(19) United States
(12) Patent Application Publication
(10) Pub. No.: US 2013/0326209 A1
(43) Pub. Date: Dec. 5, 2013

(54) Automatic Alert Mode Selection

(71) Applicants: Kalyan Chakravarthy Dommalapati, Bellevue, WA (US); Praneet Loke, Westfield, IN (US)

(72) Inventors: Kalyan Chakravarthy Dommalapati, Bellevue, WA (US); Praneet Loke, Westfield, IN (US)

(21) Appl. No.: 13/906,344

(22) Filed: May 31, 2013

Related U.S. Application Data
(60) Provisional application No. 61/655,818, filed on Jun. 5, 2012.

(51) Int. Cl. G06F 9/44

(52) U.S. Cl. CPC G06F 9/4421
USPC 713/100

(57) ABSTRACT

Automatic Alert Mode Selection may put a device into vibrate, silent, or ringer mode, or take the device out of such modes. It may automatically adjust volume settings, as applicable. It may perform these functions based on a location, a calendar entry, or an event. One embodiment may comprise a software application that communicates with network data or location sensors, such as GPS, to collect location information. It may also sync with a user's calendar to retrieve data for appointments and events. Automatic Alert Mode Selection may also interact with a plurality of application programming interfaces (APIs). In one embodiment, Automatic Alert Mode Selection may be programmed to collect data at a predetermined time interval, and in yet another embodiment, the software's functionalities may be overridden by the user.

### FIELD

This disclosure relates to Automatic Alert Mode Selection for mobile devices.

### BACKGROUND

Mobile devices such as smartphones and personal digital assistants (PDAs) are ubiquitous in today's society. Many individuals carry their mobile devices with them at virtually all times so that they can access information remotely, get in contact with other individuals, and entertain themselves.

Mobile devices typically emit an audible alert to indicate an incoming phone call, an incoming text message, the occurrence of a pre-set alarm, or for any other reason. Unfortunately, mobile devices can often make these audible alerts at times or locations that are inappropriate. For example, an individual's mobile device may ring loudly while in a crowded movie theater, ruining the movie watching experience for other viewers (or during meetings, thus disturbing the meeting). Currently, individuals must remember to manually toggle their mobile devices to a vibrate mode or a silent mode while in these situations to prevent the audible alert from disturbing others. The individual must then remember to switch the mobile device back to a ringer mode at a later time. The difficulty of remembering to toggle the phone can result in the mobile device ringing at times when the individual wants the mobile device to vibrate, and vibrating when the individual wants the mobile device to ring.

### SUMMARY

The following presents a simplified summary of the disclosure to provide a basic understanding to the reader. This summary is not an extensive overview of the disclosure, nor does it identify key or critical elements of the claimed subject matter, or define its scope. Its sole purpose is to present some concepts disclosed in a simplified form as a precursor to the more detailed description that is later presented.

The instant application discloses, among other things, techniques to provide for Automatic Alert Mode Selection. In one embodiment, a mobile device may automatically select an alert mode based on the device's particular location, a calendar event, or other preference, as determined by a user. For example, a smartphone may select a vibrate or a silent mode rather than audible mode during a meeting. The software's mobile application may interact with other application program interfaces (APIs) to gather relevant location, time, speed, calendar, or event information, or to gather other information at a predetermined time interval.

Many of the attendant features may be more readily appreciated as they become better understood by reference to the following detailed description considered in connection with the attached drawings.

### BRIEF DESCRIPTION OF THE DRAWINGS

The present description may be better understood from the following detailed description read in light of the appended drawings, wherein:

FIG. 1 is a flow diagram illustrating an Automatic Alert Mode Selection process according to one embodiment.

FIG. 2 is a user interface layout for setting location-based user preferences according to one embodiment.

FIG. 3 is a user interface layout for setting calendar-based user preferences according to one embodiment.

FIG. 4 is a flowchart illustrating an Automatic Alert Mode Selection process according to one embodiment.

FIG. 5 illustrates a component diagram of a computing device according to one embodiment.

Like reference numerals are used to designate like parts in the accompanying drawings.

### DETAILED DESCRIPTION

A more particular description of certain embodiments of Automatic Alert Mode Selection may be had by references to the embodiments shown in the drawings that form a part of this specification, in which like numerals represent like objects.

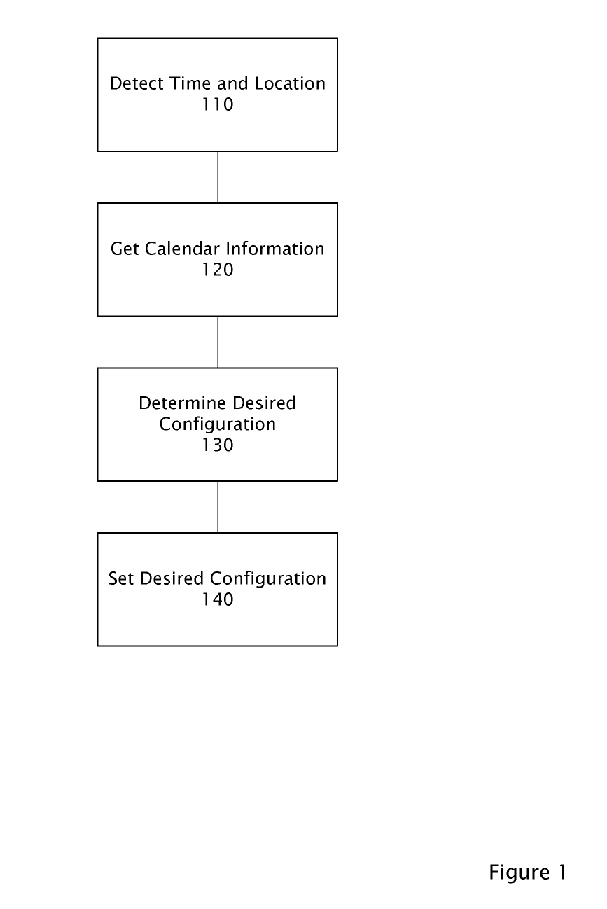

FIG. 1 is a flow diagram illustrating an Automatic Alert Mode Selection process according to one embodiment. At Detect Time and Location 110, Automatic Alert Mode Selection may obtain information from a clock and a location sensor in a mobile device. A user may configure a schedule for performing Detect Time and Location 110. Automatic Alert Mode Selection may Get Calendar Information 120, which may include using an application programming interface (API) with a calendar on the mobile device, or may include other methods of determining calendar information; for example, obtaining calendar information stored in a cloud. Location information may be determined by communicating with networks and cell phone towers, by communicating with 3rd party location service providers, for example Skyhook™, or utilizing a location sensor such as a global positioning system (GPS), or by communicating with 3rd party location service providers whereby latitude or longitude coordinates are received, to determine a current location.

Determine Desired Configuration 130 may take the time, calendar information, and location information and determine, based on user preferences, how the user wishes the mobile device to respond to alerts. For example, if a user has indicated that a meeting will be happening from 1:00 to 2:00, and it is now 1:00, Automatic Alert Mode Selection may read a desired configuration that the user has stored to apply during meetings, perhaps to provide alerts in vibrate mode. Similarly, a user may save preferences for a particular location so that, for example, alerts may be turned off, or set to silent mode, if the mobile device is in a theater\school\college\hospital etc. One having skill in the art will recognize that various classifications of calendar events, locations, other factors, or combinations of factors may be used to identify desired configurations. Automatic Alert Mode Selection may then Set Desired Configuration 140, setting alert modes on the mobile device to the settings previously saved by the user, for example toggling between the device's vibrate, ringer or silent modes, or adjusting volume settings, based on the calendar, location, time, speed, or other data received, and the user-defined settings. The mobile application may be able to determine, based on location, calendars, events, and settings selected by the user, when to alternate between the various notification modes. The mobile application may also include additional information in an SMS message. For example, if the mobile application determines that it is unsafe to use text messages, it may automatically include information in a message sent to friends or family of a user (or) in some cases disable texting temporarily.

Automatic Alert Mode Selection may operate with any mobile device, such as a smartphone, PDA, or tablet. It may also be used on any platform, for example, Android, iOS, Windows, Windows Phone, Symbian, Linux, or Blackberry. Automatic Alert Mode Selection's features and processes by which it operates may vary slightly, depending on an operating system and device.

The user may configure Automatic Alert Mode Selection to detect and monitor location changes and automatically toggle the vibration, ringer, or volume settings based on those movements. Data collected may be communicated with an API with a place-type filter, a service that returns information about popular locations, such as Google Places API or Skyhook. For example, the device may utilize a filter for movie theaters, churches, or libraries. The place-type filters may be configured based on the user's preferences, and the user may expand or edit the place-types list.

In addition, Automatic Alert Mode Selection may talk to an “event services” API to get details about events taking place at or near a user's location, and automatically adjust alerts between vibrate, audible, silent, or volume settings on the phone based on the user's preferences.

Automatic Alert Mode Selection may also talk to APIs such as Google, Yahoo, Hotmail, Exchange, Live, or any other email, calendar, event, or location service, by requesting a user to grant access to an account. Following authorization or authentication, the application may communicate with servers of the account and retrieve information.

Furthermore, Automatic Alert Mode Selection may schedule alarms or function calls, depending on an operating system, to mark an event's start and end time, and may enable toggling to take place based on a user's preferences for those alarms.

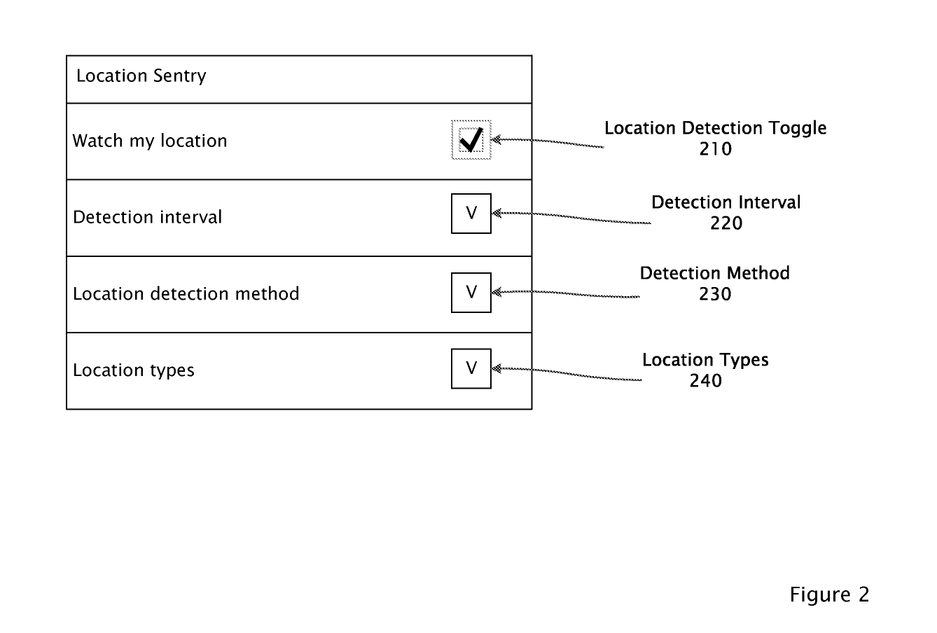

FIG. 2 is a user interface layout for setting location-based user preferences according to one embodiment. Location Detection Toggle 210 may allow a user to configure whether or not Automatic Alert Mode Selection should monitor or ignore location changes. If the user indicates that location changes should be monitored, by checking a checkbox, for example, the user may set a Detection Interval by clicking on a dropdown menu which may be available on Detection Interval 220. Detection Interval may be based on time or distance moved, or may be based on other events. Detection Method 230 may allow a user to select whether to use a global positioning system (GPS), network information, cell-phone tower triangulation, or other ways of determining location. Location Types 240 may provide a dropdown menu for a user to select various place-types and set configuration preferences for each place-type. Place-types may include but are not limited to educational institution, health institution, movie, library, government office, gym, or office. One having skill in the art will recognize that many different place-types may be determined and used.

For example, a user may indicate on a device that location information should be determined using GPS every five minutes, and that if location information indicates that the device is at a playground, alerts should be made audibly and with vibration. But if the device is in a theater, alerts should be blocked entirely, or made in silent mode. In another embodiment, location may be determined by a distance, speed and time calculation or measurement.

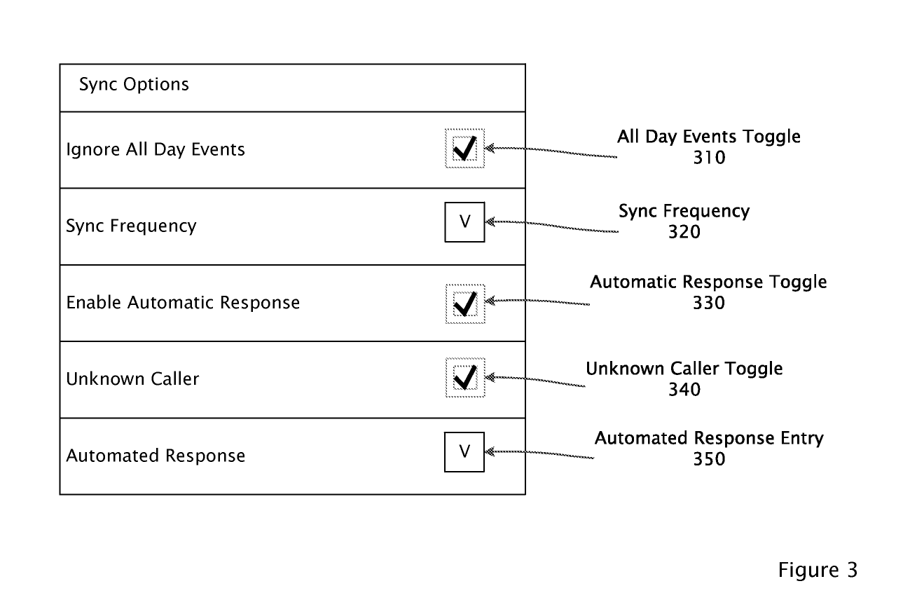

FIG. 3 is a user interface layout for setting calendar-based user preferences according to one embodiment. All Day Events Toggle 310 may allow a user to indicate whether all day events should be considered when determining alert modes. Sync Frequency 320 may allow a user to determine how often Automatic Alert Mode Selection should request data from a calendar to determine a desired alert mode.

Automatic Response Toggle 330 may allow a user to indicate whether an automatic email response should be sent if someone calls during an event-type, such as a meeting or a movie, if the user has indicated a preference not to receive phone calls. Unknown Caller Toggle 340 may indicate if the user wishes to have the same response sent to callers not in a phone book on a mobile device. Automated Response Entry 350 may provide a way to edit an automatic response, by allowing an automated SMS reply to be sent to a caller.

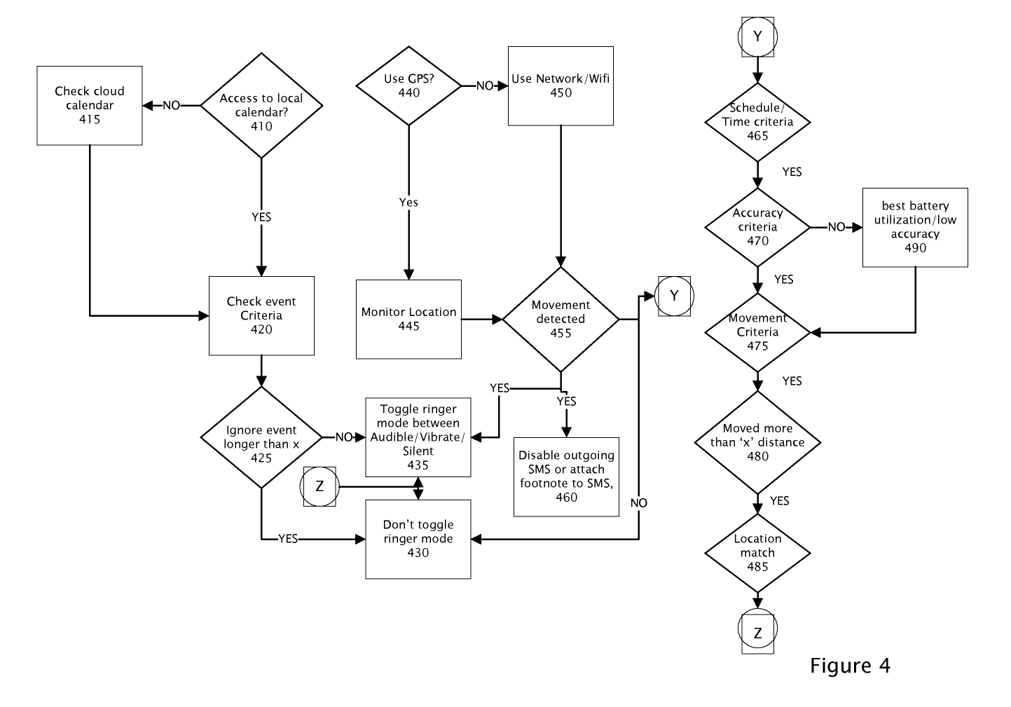

FIG. 4 is a flowchart illustrating an Automatic Alert Mode Selection process according to one embodiment. Two key triggers for toggling into or out of silent mode may be used: a calendar event and location.

Access to Local Calendar 410 may check to see if Automatic Alert Mode Selection has access to a calendar stored locally on a phone or other device. If not, it may Check a Calendar stored on a Cloud 415. Check Event Criteria 420 may include reviewing an event occurring according to a calendar, and a user's preferences. If the event is longer than a set amount of time,

Ignore Event Longer than X 425 may check to see if the event should be ignored. For example, if the calendar indicates that an event lasts all day, a user preference may be to ignore the event and Not Toggle Ringer Mode 430 Otherwise, if the event is not longer than a set time (X minutes or hours, for example), or a user preference does not indicate to ignore the event, Toggle ringer mode between Audible/Vibrate/Silent 435 may occur.

An alternative way to decide whether to switch to silent mode may be based on location. Use GPS 440 may allow checking a user's preference of whether Automatic Alert Mode Selection may use a device's GPS or other high-definition location determination system. If YES, Location may be Monitored 445. If NO, Automatic Alert Mode Selection may Use Wi-Fi, Cellular Network, or Other Means 450 to detect location. In either case, if Movement is Detected 455, SMS may be Disabled 460, and Toggle ringer mode between Audible/Vibrate/Silent 435 may occur. SMS may, for example, be limited to prevent texting while driving a car. Movement is Detected 455 may be triggered if a movement in excess of a certain distance is detected, or if a particular boundary is crossed, such as a street or the entry into a theater.

Battery consumption may be reduced by adjusting various parameters. Setting a preference concerning Schedule and Time Criteria 465, for example, may disable checking for conditions to Toggle ringer mode between Audible/Vibrate/Silent 435. For example, a setting may indicate that calendar and position tests may not need to be executed between midnight and six o'clock in the morning. Another preference setting, Accuracy Criteria 470, may indicate that accuracy requirements may be reduced at particular times or locations. If Accuracy Criteria 470 is NO, a mode providing Best Battery Utilization/Low Accuracy 490 may be implemented. Movement Criteria 475 may be tested; if movement is detected Moved More than X Distance 480 may be checked, and a Location Match 485 may be tested. Based on the result of these tests, Toggle ringer mode between Audible/Vibrate/Silent 435 or Don't Toggle Ringer Mode 430 may be performed.

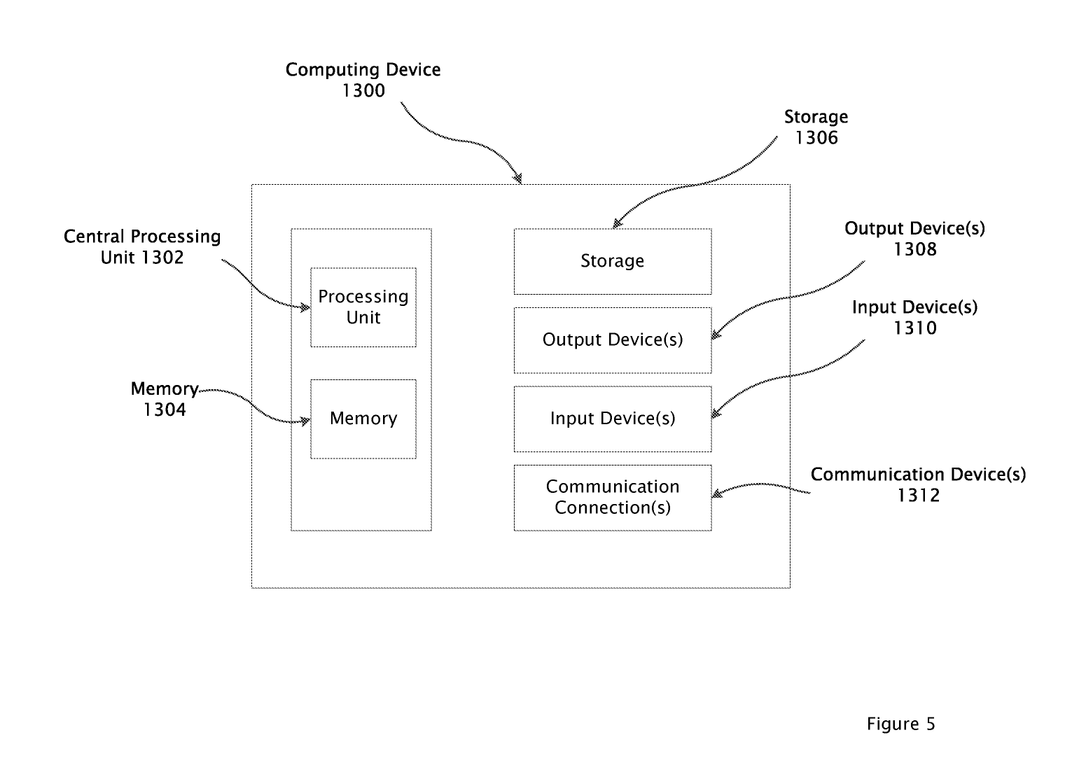

FIG. 5 illustrates a component diagram of a computing device according to one embodiment. The Computing Device (1300) can be utilized to implement one or more computing devices, computer processes, or software modules described herein, including, for example, but not limited to a mobile device. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code suitable for a mobile device. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer readable storage media includes volatile and nonvolatile, removable and non-removable media implemented in any method or technology for storage of information such as computer readable instructions, data structures, program modules or other data. Memory (1304) and Storage (1306) are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer readable storage media may be part of computing device (1300). But computer readable storage media does not include transient signals.

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A method operable on a mobile device, comprising:
determining a current time;
determining a current location;
receiving calendar information;
determining, based upon the current time, the current location, and the calendar information, a desired configuration for an alert; and
setting an alert to the desired configuration.

2. The method of claim 1 wherein the determining a current time comprises reading a clock deployed thereon.

3. The method of claim 1 wherein the determining a current location comprises requesting and receiving a location via an application programming interface supported by the mobile device.

4. The method of claim 1 wherein the receiving calendar information comprises receiving an event from a calendar deployed on the mobile device.

5. The method of claim 1 wherein the receiving calendar information comprises receiving an event from a calendar deployed on a cloud.

6. The method of claim 1 wherein determining a desired configuration for an alert comprises reading the desired configuration from a table.

7. An alert-mode setting system, comprising:
a processor;
a memory coupled to the processor;
components operable on the processor, comprising:
a time receiving component, configured to receive a current time;
a location receiving component, configured to receive a current location;
a calendar-entry receiving component, configured to receive a calendar entry, the calendar entry corresponding to the current time;
a configuration reading component, configured to read a user-saved configuration;
a configuration determining component, configured to determine a configuration based upon the current location, the calendar entry, and the user-saved configuration; and
an alert-mode setting component, configured to set an alert-mode based upon the determined configuration.

8. The system of claim 7, wherein the alert-mode is selected from a group containing vibrate, audible, silent, and disabled.
